(19) United States
(12) Patent Application Publication
(10) Pub. No.: US 2018/0365642 A1
(43) Pub. Date: Dec. 20, 2018

(54) SYSTEMS AND METHODS FOR FACILITATING PARCEL PICKUP

(71) Applicant: Sunrise R&D Holdings, LLC, Cincinnati, OH (US)

(72) Inventors: Brett Bracewell Bonner, New Richmond, OH (US); Christopher Todd HJELM, Cincinnati, OH (US)

(73) Assignee: Sunrise R&D Holdings, LLC, Cincinnati, OH (US)

(21) Appl. No.: 16/007,606

(22) Filed: Jun. 13, 2018

Related U.S. Application Data
(60) Provisional application No. 62/520,094, filed on Jun. 15, 2017.

(51) Int. Cl. G06Q 10/08; A47F 10/00

(52) U.S. Cl. CPC G06Q 10/0836; G06K 7/1413; A47F 10/00; G06Q 10/087

(57) ABSTRACT

Systems and methods for facilitating parcel pickup are disclosed. A system may include a plurality of shelves and a plurality of display units coupled to the shelves. The system may further include memory and a processor physically coupled to the memory and communicatively coupled to the display units. The processor may be configured to receive an identifier of a parcel. The processor may be further configured, in response to receiving the identifier of the parcel, to determine a shelf location among the shelves for storing the parcel. The processor may also be configured, in response to determining the shelf location, to identify one or more display units to update. The processor may additionally be configured, in response to identifying one or more display units to update, to update graphical output of the identified one or more display units identified to each present a parcel storage location indication.

### CROSS-REFERENCE TO RELATED APPLICATIONS

This application claims the benefit of U.S. Provisional Patent Application No. 62/520,094, filed on Jun. 15, 2017 and entitled “SYSTEMS AND METHODS FOR FACILITATING PARCEL PICKUP”.

### TECHNICAL FIELD

The present application generally relates to systems and methods for facilitating parcel pickup.

### BACKGROUND

Delivering parcels to individual homes may be time consuming, expensive, and burdensome. Third-party locations, such as stores, may provide a convenient location for dropping off as well as picking up parcels. However, keeping track of where various parcels have been dropped off can become error-prone and time consuming as the number of parcels grows.

Accordingly, there is a need for systems and methods for facilitating parcel pickup.

### SUMMARY

A system may comprise a plurality of shelves and a plurality of display units coupled to the shelves. The system may further comprise memory and a processor physically coupled to the memory and communicatively coupled to the display units. The processor may be configured to receive an identifier of a parcel. The processor may be further configured, in response to receiving the identifier of the parcel, to determine a shelf location among the shelves for storing the parcel. The processor may also be configured, in response to determining the shelf location, to identify one or more display units to update. The processor may additionally be configured, in response to identifying one or more display units to update, to update graphical output of the identified one or more display units identified to each present a parcel storage location indication.

A system may comprise a plurality of shelves and a plurality of display units coupled to the shelves. The system may further comprise memory and a processor physically coupled to the memory and communicatively coupled to the display units. The processor may be configured to receive an identifier of a parcel. The processor may be further configured, in response to receiving the identifier of the parcel, determine a shelf location among the shelves on which the parcel is stored. The processor may also be configured, in response to determining the shelf location on the shelves on which the parcel is stored, identify one or more of the display units to update. The processor may additionally be configured, in response to identifying the one or more display units to update, update a graphical output of the one or more display units identified to be updated to present a parcel storage location indication.

In yet another embodiment, a computer-implemented method includes receiving, automatically by a processor, an identifier of a parcel. The method may further include, in response to receiving the identifier of the parcel, determining a shelf location among the shelves for storing the parcel. The method may also include, in response to determining the shelf location, identifying one or more of the display units to update. The method may additionally include, in response to identifying one or more of the display units to update, updating graphical output of the identified one or more display units to each present a parcel storage location indication.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a modular shelving system including a plurality of display units, according to one or more embodiments shown and described herein;

FIG. 2 schematically depicts a computing network for controlling shelf display units and for facilitating parcel pickup, according to one or more embodiments shown and described herein;

FIG. 2A schematically depicts an architecture of a computing network for controlling shelf display units and for facilitating parcel pickup, according to one or more embodiments shown and described herein;

FIG. 3 schematically depicts an enterprise computing system, according to one or more embodiments shown and described herein;

FIG. 4 schematically depicts a store computing system, according to one or more embodiments shown and described herein;

FIG. 5 graphically illustrates a computer-implemented method for parcel drop off facilitation, according to one or more embodiments shown and described herein;

FIG. 6A schematically depicts parcel scanning, according to one or more embodiments shown and described herein;

FIG. 6B schematically depicts shelves containing additional parcels, according to one or more embodiments shown and described herein;

FIG. 6C schematically depicts the scanned parcel being placed on the shelves, according to one or more embodiments shown and described herein;

FIG. 6D schematically depicts the shelves containing the scanned parcel and the other parcels, according to one or more embodiments shown and described herein;

FIG. 7 graphically illustrates a computer-implemented method for parcel pickup facilitation, according to one or more embodiments shown and described herein;

FIG. 8A schematically depicts scanning of a parcel identifier, according to one or more embodiments shown and described herein;

FIG. 8B schematically depicts shelves containing parcels including the parcel corresponding to the scanned parcel identifier, according to one or more embodiments shown and described herein;

FIG. 8C schematically depicts scanning of the parcel identifier corresponding to the scanned parcel identifier, according to one or more embodiments shown and described herein; and

FIG. 8D schematically depicts the shelves without the scanned parcel, according to one or more embodiments shown and described herein.

### DETAILED DESCRIPTION

Referring generally to the figures, embodiments described herein are directed to systems and methods for facilitating parcel pickup. The embodiments herein may control shelf display units in order to display indications of where on a shelf a parcel should be placed for pickup and an indication of a location of the parcel to be picked up.

The embodiments described herein provide a marketing, pricing, planning and stocking tool useful to a grocery store or other central location that allows the grocery store or other central location to partner with one or more parcel delivery companies to enhance the capabilities of the one or more parcel delivery companies and to provide earlier delivery and more convenient pickup locations for parcels while saving time, money, and man-hours on home deliveries. As described below, shelf display units can change instantly to mark shelf space where a newly scanned in parcel should be placed for pickup, allowing a newly scanned in parcel to be placed on its own shelf space and to be easily tracked by the stores and found by the customer. With the continued rise of online shopping, grocery stores (and other retails stores) and parcel delivery companies share a high percentage of customers. A customer can schedule a grocery order and a parcel pick-up, saving time and effort for both the parcel delivery company and the customer. For these online customers, parcel pick-up at a grocery store can be safe and convenient, allowing the customer the ability to combine pick-up tasks. The parcel delivery company can substitute one delivery point for multiple home deliveries. Using a grocery store (or other retail location or central location) as a delivery point is convenient for the customer, and allows the delivery company to combine multiple home deliveries in one location, saving delivery time, man-hours, and money. Utilizing the embodiments described herein, when a customer is not at home to accept delivery, a parcel delivery company will no longer need to send a truck back to her home, make her wait for delivery next-day, or require her to make a pick-up at an 8-5 facility. In some embodiments, the driver just makes the delivery to space available on a shelf at a grocery store (or other retail location or central location). The parcel company's computer system, which contains parcel dimension, can even interface with the shelf units described herein to assure the proper available space. In some embodiments, the customer is notified by an email or text notification of the parcel's store location and she can pickup her parcel the same day. Because the embodiments described herein tie store shelving into a computer inventory control system in real time, the parcel is tracked in and out of the store. The embodiments described herein can even notify the parcel delivery company when the item is picked up. Embodiments described herein may also be desirable to those customers for whom delivery can never be early enough. Current hubs and pickup locations may be inconvenient to such customers. By facilitating pickup at grocery stores or other retail locations, which may have hundreds or thousands of locations, the embodiments described herein can immediately expand a parcel delivery company's pick-up locations. For example, a customer who desires a parcel first thing in the morning can choose a grocery store delivery location along his commute, giving him an even earlier delivery time than would otherwise be available to him. Embodiments described herein, which may be tied to grocery store scanning and payment systems, can even collect for COD parcels. Embodiments described herein allow personalization of shopping experiences for customers and can provide a higher level of convenience and personalization to parcel recipients. By offering parcel pickup locations at grocery stores, parcel delivery companies may save time and money, and immediately expand their network to many more pickup locations.

Embodiments of the systems and methods for facilitating parcel pickup will be described in more detail herein with reference to the attached figures.

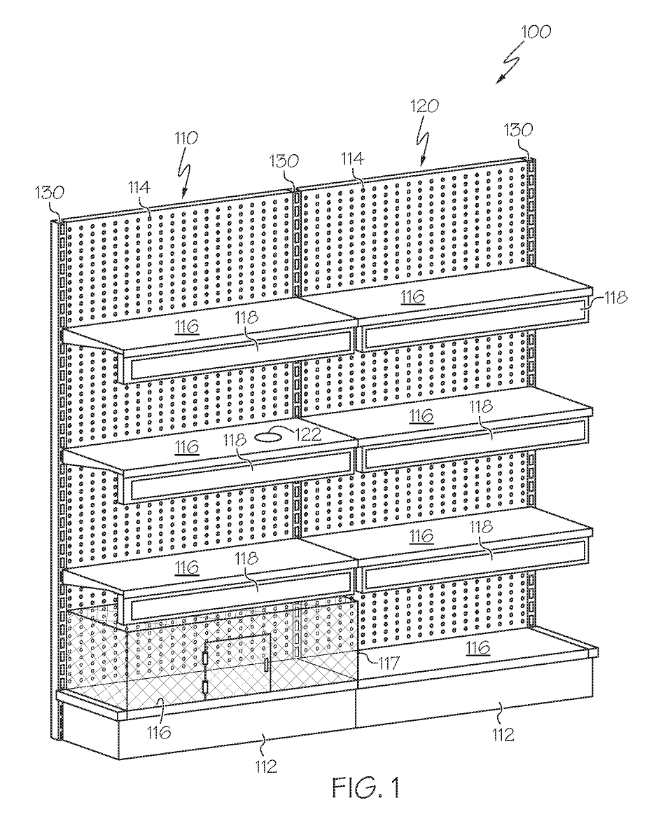

Referring now to FIG. 1, a perspective view of a modular shelving system 100 including a first shelving module 110, a second shelving module 120, and a plurality of interfacing uprights 130 is schematically depicted. Each of the first shelving module 110 and the second shelving module 120 includes a base 112, a back plane 114, a plurality of shelves 116, and a plurality of display units 118. The back plane 114 is generally planar and extends substantially perpendicularly from the base 112. The plurality of shelves 116 are secured to the plurality of interfacing uprights 130, each of which includes a plurality of apertures through which corresponding projections of the plurality of shelves 116 may be inserted to mount the plurality of shelves 116 to the shelving modules. The plurality of shelves 116 extend substantially perpendicularly from the back plane 114 in a direction that is substantially parallel to the base 112. The assembly of the shelving modules and the interfacing uprights 130 support the plurality of shelves 116 on which products may be placed. The plurality of display units 118 extend beneath the plurality of shelves 116 and are operable to display information to a person near the shelving modules, such as an indicator of a location on the plurality of shelves where a parcel to be picked up should be placed until it is picked up, an indicator of a location on the plurality of shelves where a parcel to be picked up is located, an identifier of a parcel stored proximate to the identifier, and a variety of additional information, as will be described in detail below. In this embodiment a cage 117 is depicted on a shelf to provide parcel security. Any suitable type of cage 117 configuration and/or material may be utilized. Any suitable number of cages 117 may be utilized, whereas other embodiments may not utilize any cages 117. In this embodiment, operation of the cage 117 may be based upon authentication of a customer or employee, such that the cage unlocks automatically upon such authentication. Authentication will be discussed in more detail below. Other embodiments may utilize a lock/key or any other suitable type of configuration to prevent unauthorized access into the cage 117. A cage 117 in other embodiments may be a caged room (not shown) where parcels may be securely stored.

In some embodiments, one or more sensors 122 may be utilized in any suitable location, such as within or on top of a shelf 116. In some embodiments, any sensor 122 may be a motion sensor, which may be utilized to detect motion on a shelf 116, such as when a parcel has been placed upon or removed from the shelf 116. In some embodiments, any sensor may be a light sensor, which may be utilized to detect a change in lighting with respect to a shelf 116, such as when a parcel has been placed upon or removed from the shelf 116. The change in lighting, which may be based upon a change in lighting exceeding a threshold amount of lighting change, may result in a notification being generated and/or in output being provided to one or more display units 118 or other devices.

In some embodiments, any sensor 122 may be a weight sensor, which may be utilized to detect when a parcel has been placed upon or removed from a shelf 116, where weight data from the shelf 166 may be compared to an expected weight value or an expected weight range for a parcel. For example, if a particular parcel having an expected weight value or an expected weight range is placed in an expected shelf location, weight data obtained from the weight sensor may be compared to the expected weight value or the expected weight range. If the weight of the parcel detected by the weight sensor matches an expected weight value or is within an expected weight range, a notification may be provided and/or a value indicating a correct parcel flag value may be stored. In some embodiments, a threshold may be utilized, such that even if the parcel weight deviates from an expected weight value or an expected weight range, a value indicating a correct parcel flag value or a possible-match parcel flag value may be stored and/or a notification may be generated (which may include output to one or more display units 118). Conversely, having a parcel weight value that does not match an expected weight value, that is outside of an expected weight range, or that is outside a threshold distance of an expected weight range or expected value, may result in a value (such as a correct parcel flag value) that may be stored and/or a provided as a notification (which may include output to one or more display units 118 and/or an audio notification). Some embodiments may utilize an aggregate weight value for one or more shelves 116, wherein the aggregate weight of parcels currently residing on a shelf 116 is compared against a weight limit value for the shelf 116, which may be utilized to determine how much more weight the shelf 116 can safely hold, which may be based upon a maximum weight limit, a safety limit, or a weight limit threshold range which may be modified, for example, by taking into account the amount of space remaining on other shelves 116. For example, the weight of a parcel may restrict which shelves 116 a parcel, in view of its weight, may be placed upon, such that even if a shelf 116 has sufficient free space to accommodate the parcel, the shelf 116 may not be able to handle the weight of the parcel, due to the weight of other parcels on the shelf, weight limit of the shelf, etc. In some embodiments, a weight limit and/or shelf availability may be based upon an aggregate weight limit of multiple shelves 116 associated with a modular shelving system 100 or one or more components associated therewith. In some embodiments, if a shelf 116 becomes unavailable (such as due to crashing down), the shelf 116 may be taken out of consideration for parcel placement unless/until it is fixed/restored.

Still referring to FIG. 1, in some embodiments, each of the plurality of display units 118 is powered by an Ethernet connection or through the back plane 114, as described in U.S. patent application Ser. No. 13/734,443, entitled “DISPLAY SHELF MODULES WITH PROJECTORS FOR DISPLAYING PRODUCT INFORMATION AND MODULAR SHELVING SYSTEMS COMPRISING THE SAME,” the entirety of which is incorporated by reference herein. In other embodiments, each of the plurality of display units 118 is powered by a power distribution system. In some embodiments, the plurality of display units 118 is powered in another manner, such as via batteries, or the like.

Still referring to FIG. 1, in some embodiments, each of the plurality of display units 118 includes a projector unit and a display screen, as described in U.S. patent application Ser. No. 13/734,443, entitled “DISPLAY SHELF MODULES WITH PROJECTORS FOR DISPLAYING PRODUCT INFORMATION AND MODULAR SHELVING SYSTEMS COMPRISING THE SAME,” the entirety of which is incorporated by reference herein. In other embodiments, one or more of the plurality of display units 118 includes a powered display screen, such as a TFT screen, an LCD screen, or the like. In some embodiments, the modular shelving system 100 may include one or more additional input or output components, such as a microphone (e.g., for receiving voice input from a consumer), a camera, a barcode reader, a speaker, or the like.

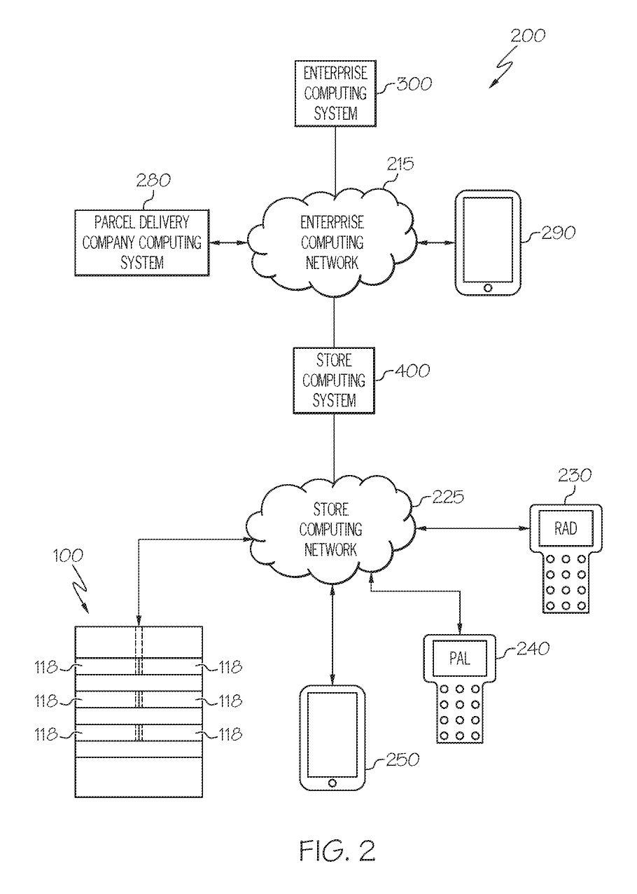

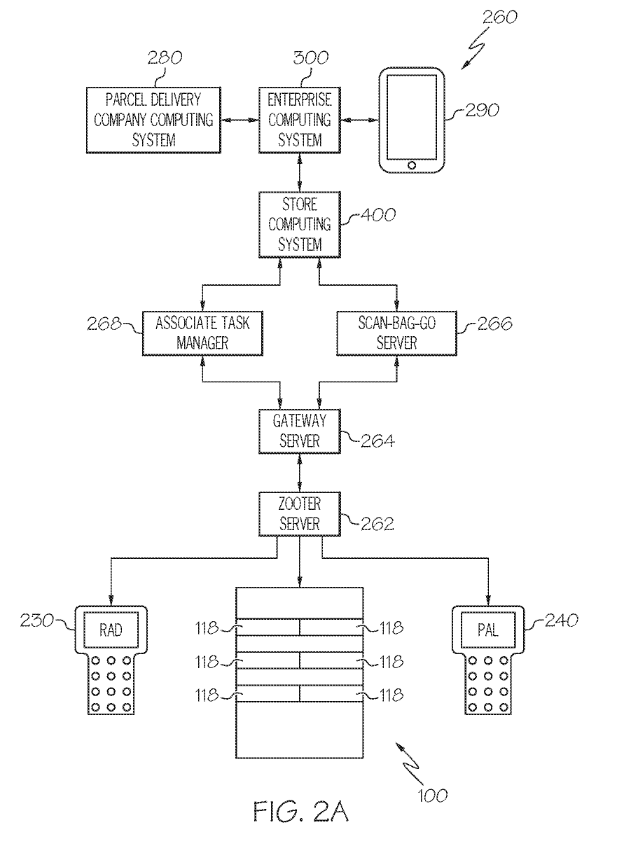

Referring now to FIG. 2, one embodiment of a computing network 200 for controlling the plurality of display units 118 and for facilitating parcel pickup is schematically depicted. In this embodiment, the computing network 200 includes an enterprise computing system 300, a parcel delivery company computing system 280, a customer computing device 290, an enterprise computing network 215, a store computing system 400, a store computing network 225, a retail associate device 230, a personal assistant and liaison device 240, a mobile computing device 250, and the plurality of display units 118.

Still referring to FIG. 2, the computing network 200 includes the enterprise computing network 215 for communicatively coupling the enterprise computing system 300, the store computing system 400, the parcel delivery company computing system and the customer computing device 290 such that data can be exchanged between the enterprise computing system 300, the store computing system 400, the parcel delivery company computing system, and the customer computing device 290. The enterprise computing network 215 may include one or more computer networks (e.g., a wide area network, a personal area network, or a local area network), one or more cellular networks, one or more satellite networks, or combinations thereof. Accordingly, each of the enterprise computing system 300, the store computing system 400, the parcel delivery company computing system 280, and the customer computing device 290 may be communicatively coupled to the enterprise computing network 215 via a wide area network, via a local area network, via a personal area network, via a cellular network, via a satellite network, or the like. Suitable wide area networks may include wired or wireless telecommunications networks that transmit information via coaxial cables, fiber-optic cables, radio-frequency transmission, or the like. Suitable local area networks may include wired ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Still referring to FIG. 2, the enterprise computing network 215 communicatively couples the enterprise computing system 300, the store computing system 400, the parcel delivery company computing system 280, and the customer computing device 290 such that data may be exchanged between the systems. In some embodiments, the enterprise computing system 300 stores enterprise data and interacts with a plurality of store computing systems associated with a plurality of stores. For example, the enterprise computing system 300 may be a central computing system operated by an owner of a grocery store chain or other retailer that owns a plurality of stores for selling products. Each of the plurality of store computing systems may be associated with a store affiliated with, owned, or operated by the grocery store chain or other retailer. Each of the plurality of store computing systems may receive information from the enterprise computing system 300 and use the received data, along with other data input to the store computing system by devices located at the store, to interface with and interact with any number of electronic components (e.g., cameras, point of sale devices, shelf displays, lighting systems, retail associate devices, personal assistant and liaison devices, etc.) at the store.

Still referring to FIG. 2, the enterprise computing system 300 stores enterprise data for distribution to a plurality of store computing systems, such as the store computing system 400, the parcel delivery company computing system 280, the customer computing device 290, and the like. For example, the enterprise computing system 300 may store product data pertaining to products to be sold at one or more store locations, pricing data pertaining to the products to be sold at the one or more store locations, planogram data pertaining to the placement of products, parcels, or other items on shelves, label data to be displayed on shelf display units at the one or more store locations, multimedia content (e.g., pictures, video, sound, or the like), information on parcels stored at particular store location for pickup, and the like. The enterprise computing system 300 may facilitate the interaction with and control of the plurality of display units 118 of the modular shelving system, as will be described below.

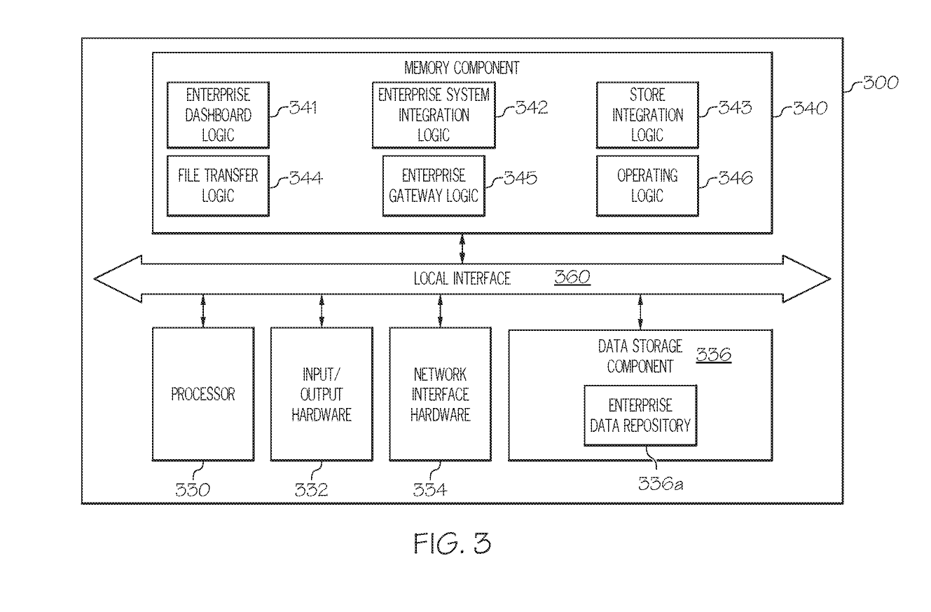

The enterprise computing system 300 may also communicate with the parcel delivery company computing system 280, such as to send or receive information (e.g., dimensions, weight, identifier, etc.) related to parcels to be placed on the plurality of shelves 116 for pickup, to send or receive information related to the status of parcels picked up at a store (e.g., a time and date of drop off of a parcel to a store by a parcel delivery company, a time and date of a pickup of the parcel by a customer, and the like), to facilitate payment of a collect on delivery payment via in-store payment professing infrastructure, or the like. The enterprise computing system 300 may also communicate with the customer computing device 290, such as to receive a pickup time request from a customer, to send a customer a notification (e.g., email or SMS text message) of a parcel located at the store for pickup, or the like. Further components and functionality of the enterprise computing system 300 will be described with reference to FIG. 3 below.

Still referring to FIG. 2, the store computing system 400 may receive information from the enterprise computing system 300 and use the received data, along with other data input to the store computing system by devices located at the store, to interface with and interact with any number of electronic components (e.g., cameras, point of sale devices, shelf displays, lighting systems, retail associate devices, personal assistant and liaison devices, etc.) at the store. The store computing system 400 may also facilitate the interaction with and control of the plurality of display units 118 of the modular shelving system, as will be described below. Further components and functionality of the store computing system 400 will be described with reference to FIG. 3 below.

Still referring to FIG. 2, each of the enterprise computing system 300, the store computing system 400, the parcel delivery company computing system 280, and the customer computing device 290 may be implemented as one or more computing devices, such as but not limited to server computers, personal computers, mobile computing devices, and the like. Furthermore, while each of the enterprise computing system 300, the store computing system 400, the parcel delivery company computing system 280, and the customer computing device 290 are depicted in FIG. 2 as a single piece of hardware, embodiments are not so limited. For example, in some embodiments, one or more of the enterprise computing system 300, the store computing system 400, the parcel delivery company computing system 280, and the customer computing device 290 may be implemented as a plurality of computing devices interconnected by a network.

Still referring to FIG. 2, the computing network 200 includes the store computing network 225 for communicatively coupling the store computing system 400 to the retail associate device 230, the personal assistant and liaison device 240, the mobile computing device 250, and the plurality of display units 118, such that data can be exchanged between the components. The store computing network 225 may include one or more computer networks (e.g., a wide area network, a personal area network, or a local area network), one or more cellular networks, one or more satellite networks, or combinations thereof. Accordingly, each of the retail associate device 230, the personal assistant and liaison device 240, the mobile computing device 250, and the plurality of display units 118 may be communicatively coupled to the store computing network 225 via a wide area network, via a local area network, via a personal area network, via a cellular network, via a satellite network, or the like. Suitable wide area networks may include wired or wireless telecommunications networks that transmit information via coaxial cables, fiber-optic cables, radio-frequency transmission, or the like. Suitable local area networks may include wired ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

Still referring to FIG. 2, the store computing network 225 communicatively couples the store computing system 400, the retail associate device 230, the personal assistant and liaison device 240, the mobile computing device 250, and the plurality of display units 118 such that data may be exchanged between the components of the network. The store computing system 400 may receive data from and provide data to the retail associate device 230, the personal assistant and liaison device 240, the mobile computing device 250, and the plurality of display units 118.

Still referring to FIG. 2, in embodiments, the retail associate device 230 is a mobile computing device that may be used by a retail associate at a store to assist in the performance of a variety of functions, such as restocking shelves, resetting planograms, scanning product SKUs, retrieving products ordered by customers, scanning parcels dropped off by a parcel delivery company for pickup by a customer, scanning parcels picked up by a customer, and the like. The retail associate device 230 is a computing device that includes a processor, a data storage component, a non-transitory memory component, input/output hardware, network interface hardware, and a local interface. The processor of the retail associate device 230 includes a processing component configured to receive and execute instructions from the data storage component of the memory component. The memory component of the retail associate device 230 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. The data storage device or the memory component may be configured to store logic that causes the retail associate device 230 to perform the functions described herein when executed by the processor. The input/output hardware of the retail associate device 230 may include a display device (e.g., a touch screen, LCD screen, plasma screen, TFT screen, or the like), a tactile input device (e.g., a keypad, button, keyboard, mouse, or the like), a camera, a barcode reader, a microphone, a speaker, or the like, for receiving, sending, and/or presenting data. The network interface hardware of the retail associate device 230 may include any wired or wireless networking hardware, such as a modem, LAN port, wireless fidelity (Wi-Fi) card, WiMax card, mobile communications hardware, and/or other hardware for communicating with the store computing network 225 or with other devices. The local interface of the retail associate device 230 may be implemented as a bus or other interface to facilitate communication among the components of the retail associate device 230. While FIG. 2 only depicts a single retail associate device 230, some embodiments may include a plurality of retail associate devices, each of which may be carried and used by a different retail associate.

Still referring to FIG. 2, the personal assistant and liaison device 240 is a mobile computing device that may be used by a shopper at a store to perform a variety of functions, such as to scan and pay for products, to access shopping lists, to scan parcels picked up by the shopper, or the like. The personal assistant and liaison device 240 is a computing device that includes a processor, a data storage component, a non-transitory memory component, input/output hardware, network interface hardware, and a local interface. The processor of the personal assistant and liaison device 240 includes a processing component configured to receive and execute instructions from the data storage component of the memory component. The memory component of the personal assistant and liaison device 240 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. The data storage device or the memory component may be configured to store logic that causes the personal assistant and liaison device 240 to perform the functions described herein when executed by the processor. The input/output hardware of the personal assistant and liaison device 240 may include a display device (e.g., a touch screen, LCD screen, plasma screen, TFT screen, or the like), a tactile input device (e.g., a keypad, button, keyboard, mouse, or the like), a camera, a barcode reader, a microphone, a speaker, or the like, for receiving, sending, and/or presenting data. The network interface hardware of the personal assistant and liaison device 240 may include any wired or wireless networking hardware, such as a modem, LAN port, wireless fidelity (Wi-Fi) card, WiMax card, mobile communications hardware, and/or other hardware for communicating with the store computing network 225 or with other devices. The local interface of the personal assistant and liaison device 240 may be implemented as a bus or other interface to facilitate communication among the components of the personal assistant and liaison device 240. While FIG. 2 only depicts a single personal assistant and liaison device 240, some embodiments may include a plurality of personal assistant and liaison devices, each of which may be carried and used by a different customer.

Still referring to FIG. 2, the mobile computing device 250 may be a mobile phone, a smartphone, a tablet, a personal digital assistant, a dedicated mobile media player, a mobile personal computer, a laptop computer, and/or any other mobile device including computing components. In some embodiments, the mobile computing device 250 may be used by a retail associate (e.g., when a retail associate uses the mobile computing device 250 to perform associate functions instead of the retail associate device 230). In some embodiments, the mobile computing device 250 may be used by a customer (e.g., when a customer uses the mobile computing device 250 instead of the personal assistant and liaison device 240 while shopping). In some embodiments, the mobile computing device 250 may be used by a retail associate or customer in addition to the retail associate device 230 or the personal assistant and liaison device 240. The mobile computing device 250 is a computing device that includes a processor, a data storage component, a non-transitory memory component, input/output hardware, network interface hardware, and a local interface. The processor of the mobile computing device 250 includes a processing component configured to receive and execute instructions from the data storage component of the memory component. The memory component of the mobile computing device 250 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. The data storage device or the memory component may be configured to store logic that causes the mobile computing device 250 to perform the functions described herein when executed by the processor. The input/output hardware of the mobile computing device 250 may include a display device (e.g., a touch screen, LCD screen, plasma screen, TFT screen, or the like), a tactile input device (e.g., a keypad, button, keyboard, mouse, or the like), a camera, a barcode reader, a microphone, a speaker, or the like, for receiving, sending, and/or presenting data. The network interface hardware of the mobile computing device 250 may include any wired or wireless networking hardware, such as a modem, LAN port, wireless fidelity (Wi-Fi) card, WiMax card, mobile communications hardware, and/or other hardware for communicating with the store computing network 225 or with other devices. The local interface of the mobile computing device 250 may be implemented as a bus or other interface to facilitate communication among the components of the mobile computing device 250. While FIG. 2 only depicts a single mobile computing device 250, some embodiments include a plurality of mobile computing devices, each communicatively coupled to the store computing system 400 by the store computing network 225.

While the computing network 200 depicted in FIG. 2 includes both the enterprise computing network 215 and the store computing network 225, it should be understood that in other embodiments, the enterprise computing system 300, the store computing system 400, the parcel delivery company computing system 280, the customer computing device 290, the retail associate device 230, the personal assistant and liaison device 240, the mobile computing device, and the plurality of display units 118, may be communicatively coupled by a single computer network, or by additional computer networks other than the enterprise computing network 215 and the store computing network 225.

Referring now to FIG. 2A, an architecture of a computing network 260 is schematically depicted. The computing network 260 includes the enterprise computing system 300 the store computing system 400, the parcel delivery company computing system 280, the customer computing device 290, the retail associate device 230, the personal assistant and liaison device 240, the plurality of display units 118, a zooter server 262, a gateway server 264, a scan-bag-go server 266, and an associate task manager server 268. Each of the zooter server 262, the gateway server 264, the scan-bag-go server 266, and the associate task manager server 268 includes a processor, a data storage component, a non-transitory memory component, input/output hardware, network interface hardware, and a local interface. Each of the components depicted in FIG. 2A are interconnected by one or more computing networks, which are not separately depicted. The associate task manager server 268 relays information between the retail associate device 230 and the store computing system 400. The scan-bag-go server 266 relays information between the personal assistant and liaison device 240 and the store computing system 400. The gateway server 264 relays information among the associate task manager server 268, the scan-bag-go server 266, and the zooter server 262. The zooter server 262 relays information among the gateway server 264, the plurality of display units 118, the personal assistant and liaison device 240, and the retail associate device 230. The specific architecture depicted in FIG. 2A does not limit the embodiments described herein. Other architectures may not include one or more of the depicted components, such as embodiments that do not include one or more of the intermediary components (e.g., the associate task manager server 268, the scan-bag-go server 266, the gateway server 264, or the zooter server 262).

FIG. 3 depicts additional details regarding the enterprise computing system 300 from FIG. 2. In some embodiments, the enterprise computing system 300 may be configured as a general purpose computer with the requisite hardware, software, and/or firmware. In some embodiments, the enterprise computing system 300 may be configured as a special purpose computer designed specifically for performing the functionality described herein.

As illustrated in FIG. 3, the enterprise computing system 300 includes a processor 330, input/output hardware 332, network interface hardware 334, a data storage component 336, and a non-transitory memory component 340. The memory component 340 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 340 may be configured to store enterprise dashboard logic 341, enterprise system integration logic 342, store integration logic 343, file transfer logic 344, enterprise gateway logic 345, and operating logic 346 (each of which may be embodied as a computer program, firmware, or hardware, as an example). A local interface 350 is also included in FIG. 3 and may be implemented as a bus or other interface to facilitate communication among the components of the enterprise computing system 300.

Still referring to FIG. 3, the processor 330 may include any processing component configured to receive and execute instructions (such as from the data storage component 336 and/or memory component 340). The input/output hardware 332 may include a monitor, keyboard, mouse, printer, camera, microphone, speaker, touch-screen, and/or other device for receiving, sending, and/or presenting data. The network interface hardware 334 may include any wired or wireless networking hardware, such as a modem, LAN port, wireless fidelity (Wi-Fi) card, WiMax card, mobile communications hardware, and/or other hardware for communicating with other networks (e.g., the enterprise computing network 215) and/or devices.

The data storage component 336 may reside local to and/or remote from the enterprise computing system 300 and may be configured to store one or more pieces of data for access by the enterprise computing system 300 and/or other components. As illustrated in FIG. 3, the data storage component 336 may store an enterprise data repository 336a, which may include product data pertaining to products to be sold at one or more store locations, pricing data pertaining to the products to be sold at the one or more store locations, planogram data pertaining to the placement of products on shelves, and label data to be displayed on shelf display units at the one or more store locations, multimedia content (e.g., pictures, video, sound, or the like), information on parcels stored at particular store location for pickup, and the like. The enterprise data repository 336a may be stored in one or more data storage devices. In another embodiment, the enterprise computing system 300 may be coupled to a remote server or data storage device that includes at least some of the data in the enterprise data repository 336a. Other data may be stored in the data storage component 336 to provide support for functionalities described herein.

Still referring to FIG. 3, the memory component 340 includes the enterprise dashboard logic 341, the enterprise system integration logic 342, the store integration logic 343, the file transfer logic 344, the enterprise gateway logic 345, and the operating logic 346. The enterprise dashboard logic 341 includes machine readable instructions that when executed by the processor 330 cause the enterprise computing system 300 to display a graphical user interface for managing the enterprise data repository 336a. In some embodiments, the graphical user interface may allow for the management or adjustment of data to be transmitted to the store computing system 400 or to be displayed one the plurality of display units 118. In some embodiments, the graphical user interface may allow for control of the content displayed on the plurality of display units 118. The enterprise system integration logic 342 includes machine readable instructions that when executed by the processor 330 cause the enterprise computing system 300 to process events from other enterprise services. In some embodiments, the enterprise system integration logic 342 receives and handles planogram events, such as the updating of planograms. The store integration logic 343 includes machine readable instructions that when executed by the processor 330 cause the enterprise computing system 300 to transmit messages or data to the store computing system 400 or receive messages or data from the store computing system 400. The file transfer logic 344 includes machine readable instructions that when executed by the processor 330 cause the enterprise computing system 300 to transfer files, such as video or other multimedia files to the store computing system 400. In some embodiments, the file transfer logic 344 includes an IBM MQ extension that facilitates the transfer of video files to the store computing system 400 so that the store computing system 400 causes the video files to be displayed on at least one of the plurality of display units 118. The enterprise gateway logic 345 includes machine readable instructions that when executed by the processor 330 cause the enterprise computing system 300 to transmit messages to or receive messages from the store computing system 400. In some embodiments, the enterprise gateway logic 345 may transmit and receive all messages to and from the store computing system 400, but may forward or receive only messages pertaining to the plurality of display units 118 to the store integration logic 343. The operating logic 346 may include an operating system and/or other software for managing components of the enterprise computing system 300.

It should be understood that the components illustrated in FIG. 3 are merely exemplary and are not intended to limit the scope of this disclosure. More specifically, while the components in FIG. 3 are illustrated as residing within the enterprise computing system 300, this is a non-limiting example. In some embodiments, one or more of the components may reside external to the enterprise computing system 300.

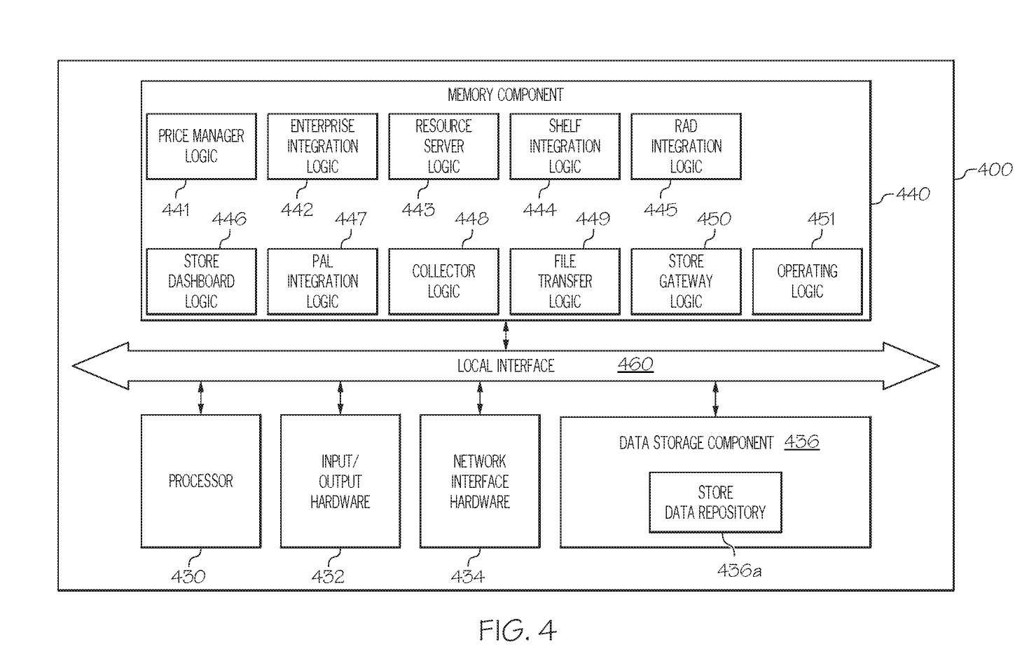

FIG. 4 depicts additional details regarding the store computing system 400 from FIG. 2. In some embodiments, the store computing system 400 may be configured as a general purpose computer with the requisite hardware, software, and/or firmware. In some embodiments, the store computing system 400 may be configured as a special purpose computer designed specifically for performing the functionality described herein.

As illustrated in FIG. 4, the store computing system 400 includes a processor 430, input/output hardware 432, network interface hardware 434, a data storage component 436, and a non-transitory memory component 440. The memory component 440 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 440 may be configured to store price manager logic 441, enterprise integration logic 442, resource server logic 443, shelf integration logic 444, RAD integration logic 445, store dashboard logic 446, PAL integration logic 447, collector logic 448, file transfer logic 449, store gateway logic 450, and operating logic 451 (each of which may be embodied as a computer program, firmware, or hardware, as an example). A local interface 460 is also included in FIG. 4 and may be implemented as a bus or other interface to facilitate communication among the components of the store computing system 400.

Still referring to FIG. 4, the processor 430 may include any processing component configured to receive and execute instructions (such as from the data storage component 436 and/or memory component 440). The input/output hardware 432 may include a monitor, keyboard, mouse, printer, camera, microphone, speaker, touch-screen, and/or other device for receiving, sending, and/or presenting data. The network interface hardware 434 may include any wired or wireless networking hardware, such as a modem, LAN port, wireless fidelity (Wi-Fi) card, WiMax card, mobile communications hardware, and/or other hardware for communicating with other networks (e.g., the enterprise computing network 215 or the store computing network 225) and/or devices.

The data storage component 436 may reside local to and/or remote from the store computing system 400 and may be configured to store one or more pieces of data for access by the store computing system 400 and/or other components. As illustrated in FIG. 4, the data storage component 436 may store a store data repository 436a, which may include product data pertaining to products to be sold at the store, pricing data pertaining to the products to be sold at the store, planogram data pertaining to the placement of products on shelves at the store, and label data to be displayed on shelf display units at the store, multimedia content (e.g., pictures, video, or the like), information on parcels stored at particular store location for pickup, and the like. The store data repository 436a may be stored in one or more data storage devices. In another embodiment, the store computing system 400 may be coupled to a remote server or data storage device that includes at least some of the data in the store data repository 436a. Other data may be stored in the data storage component 436 to provide support for functionalities described herein.

Still referring to FIG. 4, the memory component 440 includes the price manager logic 441, the enterprise integration logic 442, the resource server logic 443, the shelf integration logic 444, the RAD integration logic 445, the store dashboard logic 446, the PAL integration logic 447, the collector logic 448, the file transfer logic 449, the store gateway logic 450, and the operating logic 451. The collector logic 448 includes machine readable instructions that when executed by the processor 430 cause the store computing system 400 to collect data from a number of resources (e.g., price data, point of sale information, label information, etc.) and transmits electronic shelf label events to the price manager logic. The price manager logic 441 includes machine readable instructions that when executed by the processor 430 cause the store computing system 400 to process the electronic shelf label events transmitted by the collector logic 448. The enterprise integration logic 442 includes machine readable instructions that when executed by the processor 430 cause the store computing system 400 to transmit messages or data to the enterprise computing system 300 or receive messages or data from the enterprise computing system 300. The resource server logic 443 includes machine readable instructions that when executed by the processor 430 cause the store computing system 400 to render image or video data, such as tags, banners, tag templates, or video content to be displayed on the plurality of display units 118. The shelf integration logic 444 sends messages or content to the plurality of display units 118 for display by the plurality of display units 118. In some embodiments, the shelf integration logic 444 may be external to the store computing system 400. The RAD integration logic 445 includes machine readable instructions that when executed by the processor 430 cause the store computing system 400 to receive messages from and transmits messages to the retail associate device 230. The store dashboard logic 446 includes machine readable instructions that when executed by the processor 430 cause the store computing system 400 to display a graphical user interface for managing the store data repository 436a. In some embodiments, the graphical user interface may allow for the management or adjustment of data to be displayed one the plurality of display units 118. In some embodiments, the graphical user interface may allow for control of the content displayed on the plurality of display units 118. The PAL integration logic 447 includes machine readable instructions that when executed by the processor 430 cause the store computing system 400 to receive messages from and transmit messages to the personal assistant and liaison device 240. The file transfer logic 449 includes machine readable instructions that when executed by the processor 430 cause the store computing system 400 to receive files, such as video or other multimedia files from the enterprise computing system 300. In some embodiments, the file transfer logic 449 includes an IBM MQ extension that facilitates the transfer of video files to the store computing system 400. The store gateway logic 450 includes machine readable instructions that when executed by the processor 430 cause the store computing system 400 to transmit messages to or receive messages from the enterprise computing system 300. In some embodiments, the store gateway logic 450 may transmit and receive all messages to and from the enterprise computing system 300, but may forward or receive only messages pertaining to the plurality of display units 118 to the enterprise integration logic 442. The operating logic 451 may include an operating system and/or other software for managing components of the store computing system 400.

It should be understood that the components illustrated in FIG. 4 are merely exemplary and are not intended to limit the scope of this disclosure. More specifically, while the components in FIG. 4 are illustrated as residing within the store computing system 400, this is a non-limiting example. In some embodiments, one or more of the components may reside external to the store computing system 400.

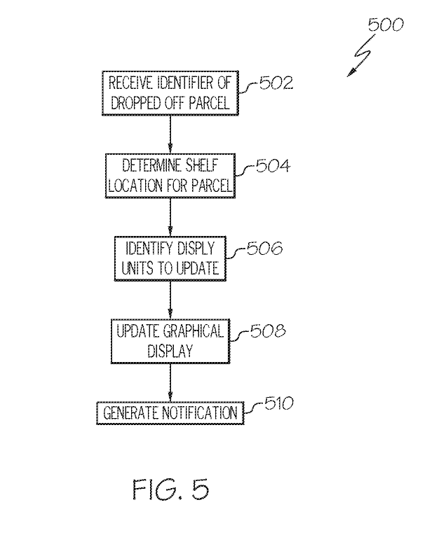

Referring now to FIG. 5 (and FIGS. 1 and 2), a flowchart that graphically illustrates a method 500 for parcel drop off facilitation is provided. As will be apparent from the description below, the method 500 may facilitate the drop off of a parcel for later pickup by a customer in a manner that includes determining a shelf location for the parcel to be stored, presenting a parcel location indication on the plurality of display units 118 such that the plurality of display units 118 provide a visual cue for the parcel to be placed on the plurality of shelves 116, and generating a notification of the parcel having been dropped off for subsequent pickup.

Still referring to FIG. 5 (and FIGS. 1 and 2), at block 502, an identifier of a dropped off parcel is received. The identifier may be received in a number of ways, including in response to scanning an identifier of the parcel with a computing device (e.g., with the retail associate device 230, the personal assistant and liaison device 240, the mobile computing device 250), in response to input provided to the input/output hardware 422 of the store computing system 400, via direct entry into a computing device, or the like.

Still referring to FIG. 5 (and FIGS. 1 and 2), at block 504, in response to receiving the identifier of the dropped off parcel, a shelf location on the plurality of shelves 116 for storing the dropped off parcel may be determined. The shelf location may be determined based on parcel dimension or weight data, which may be provided by the parcel delivery company computing system 280 in response to a request for such information sent by at least one of the enterprise computing system 300 and the store computing system 400. The shelf location may also be determined based on planogram data or parcel storage configuration data of where other parcels are currently located and where empty shelf space sufficient to accommodate the dropped off parcel exists. In some embodiments, the shelf location is determined as an empty location on the plurality of shelves 116 capable of accommodating the dimensions and weight of the parcel.

Still referring to FIG. 5 (and FIGS. 1 and 2), at block 506, in response to determining the shelf location on the plurality of shelves 116 for storing the dropped off parcel, at least one of the plurality of display units 118 to update may be identified. In some embodiments, the display units to be updated may be identified by the store computing system 400 based on planogram data or parcel storage configuration data stored in the store data repository 436a or planogram data or parcel storage configuration data stored in the enterprise data repository 336a that maps the location of the plurality of shelves 116 for storing the dropped off parcel to one or more of the plurality of display units 118.

Still referring to FIG. 5 (and FIGS. 1 and 2), at block 508, in response to identifying the one or more display units to update, a graphical output of the one or more display units identified to be updated in block 506 may be updated to present a parcel storage location indication. In some embodiments, the parcel storage location indication may be indicative of a location on a shelf above or below the one or more display units on which the parcel is to be placed for later pickup. In some embodiments, the graphical output of one or more of the identified display units may be updated to include an arrow pointing to the location on the plurality of shelves 116 on which the parcel is to be placed for later pickup. In some embodiments, the graphical output of one or more of the identified display units may be updated to include an animation indicative of the location on the plurality of shelves 116 on which the parcel is to be placed for later pickup. In some embodiments, a color of the background of one or more of the identified display units may be changed relative to the background of the display units that are not associated with the location on the plurality of shelves 116 on which the parcel is to be placed for later pickup. In other embodiments, a graphical output of the identified display units may be updated in a different manner to graphically distinguish the display units associated with the location on which the parcel is to be placed for later pickup from the other display units. By presenting the parcel storage location indication on the appropriate display unit or display units, placing the parcel to be picked up later in an appropriate place on the plurality of shelves 116 may be facilitated by providing a visual cue that allows quick and accurate identification of the appropriate location of the parcel for future pickup. In some embodiments, the graphical output of the one or more display units identified to be updated may be updated to present the parcel storage location indication in response to a message and/or content transmitted from the store computing system 400 to the one or more display units 118 via the store computing network 225. In some embodiments, the resource server logic 443 of the store computing system 400 may render the image or video data to be displayed on the plurality of display units 118 as the updated graphical output. In some embodiments, the shelf integration logic 444 of the store computing system 400 sends the message or content to the plurality of display units 118 that cause the graphical output to be updated. In some embodiments, an audible parcel storage location indication may be provided by a speaker positioned near the location where the parcel is to be placed for later pickup.

Still referring to FIG. 5 (and FIGS. 1 and 2), at block 510, a notification of the parcel drop off is generated. A notification may be sent to the parcel delivery company computing system 280 to indicate that the parcel has been dropped off at the store and is ready for pickup. A notification may be sent to the customer (e.g., from the enterprise computing system 300 to the customer computing device 290) indicating that a parcel is available for the customer to pickup at the store. The notification may include many types of data, such as an identifier of the parcel, a location of the store, a time that the parcel may be picked up, and the like. Such notifications may facilitate the tracking the parcel by the store, the parcel delivery company and/or the customer.

Although blocks 502-510 have been described as being separate tasks, in other embodiments, the blocks may be combined or omitted. Further, while the tasks of blocks 502-510 have been described as being performed in a particular order, in other embodiments, the tasks may be performed in a different order.

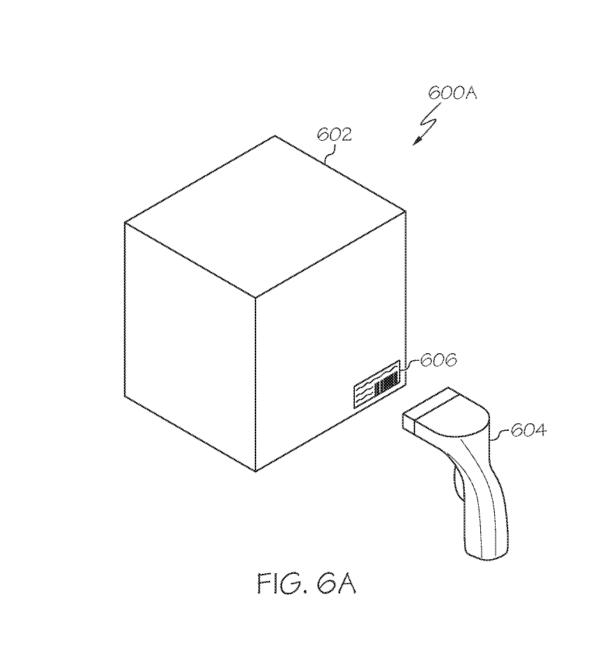

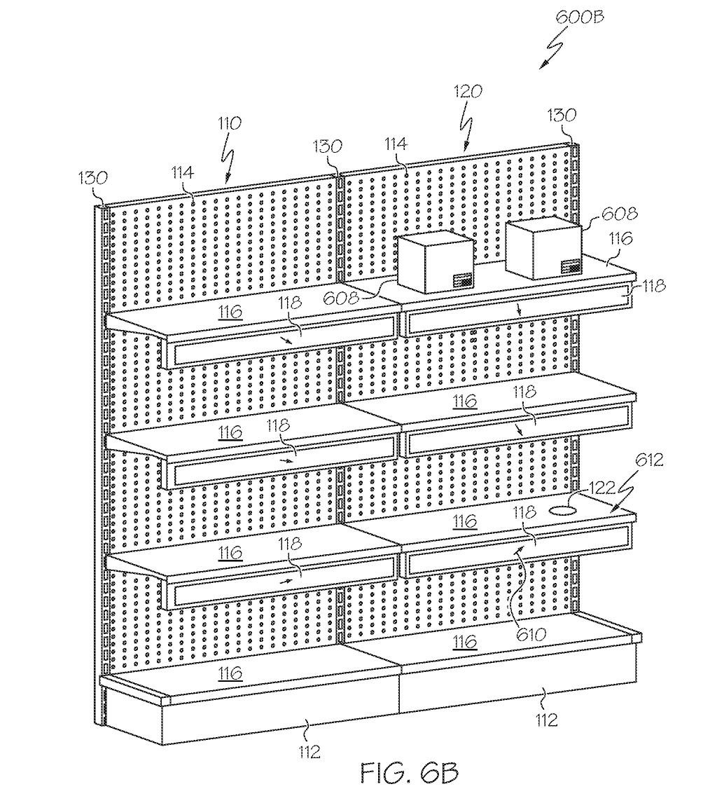

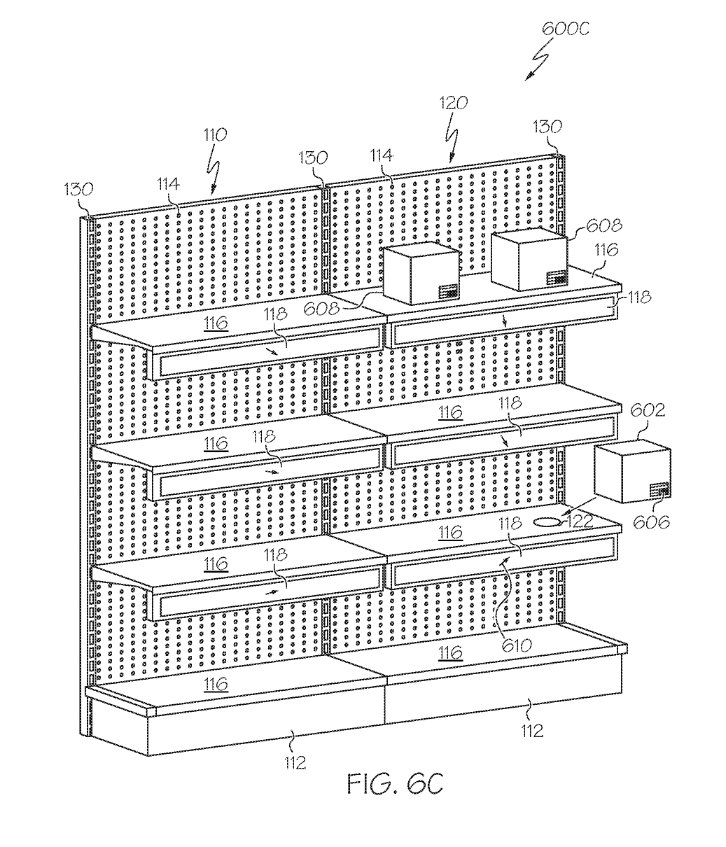

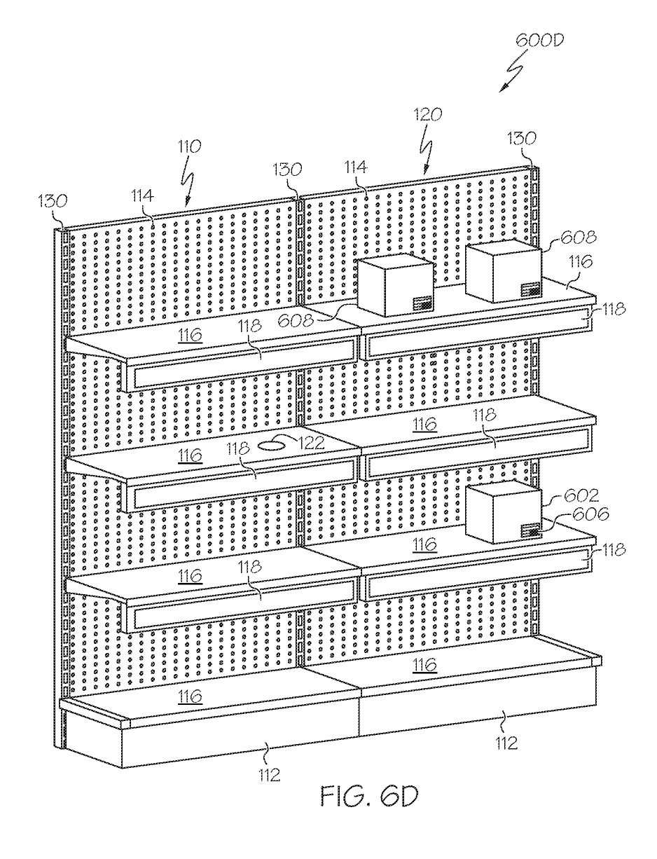

FIG. 6A schematically depicts the scanning of a subject parcel 602. An input device 604, which is a hand-held laser scanner in this embodiment, scans an identifier 606 on the subject parcel 602. Although a laser scanner and a barcode are depicted here, any suitable type of input device 604 (RFID reader, etc.) and identifier 606 (QR code, RFID, etc.) may be utilized. In some embodiments, the identifier 606 may be located inside of, or remote from, the subject parcel 602. The identifier 606 may be provided to an enterprise computing system 300, store computing system 400, and/or any other computing system. In some embodiments, employee identification, validation, and/or authentication may be further provided. Biometrics may be implemented via any suitable hardware, such as cameras, microphones, and/or touch-screens, which are discussed above with respect to 432 FIG. 4. For example, camera-captured biometrics (facial recognition technology, finger print scanning, eye scanning, etc.) may be utilized to authenticate an employee for purposes of dropping off the parcel 602. Any suitable type biometrics may be utilized, although other mechanisms may be utilized. For example, an employee may be able to swipe or scan their ID (employee ID, driver's license, passport, etc.), or have it verified by another employee that can enter the ID information or enter general approval information.

Turning now to FIG. 6B, shelves 116 containing additional parcels are schematically depicted. In this embodiment, other parcels 608 are located on the shelves 116 and one or more display units 118 may provide display unit output 610 (such as an arrow) indicating where the recipient spot 612 is located on the shelves 116 (e.g., where the subject parcel 602 is designated to be placed for storage). This may be in response to the subject parcel 602 being scanned, as depicted in FIG. 6A. For example, the display unit 118 immediately below the recipient spot 612 may display an arrow as display unit output 610 pointing upward towards the recipient spot 612. In other embodiments, only display units 118 without other parcels 608 may display arrows pointing towards a recipient spot 612. A display unit 118 may be configured to display an arrow whose direction corresponds to the location of a recipient spot 612 relative to the location of the display unit 118. Any type of visual or audio indicator may be provided as display unit output 610 to indicate the location of the recipient spot 612. In some embodiments, there may be multiple recipient spots 612 or none at all.

Turning now to FIG. 6C, placement of the subject parcel 602 in the recipient spot 612 on a shelf 116 is schematically depicted. As discussed above, one or more sensors 122 (such as a weight sensor, a motion sensor, or a light sensor) may be utilized to detect that the subject parcel 602 has been placed on the recipient spot 612. In some embodiments, data representing placement of the subject parcel 602 upon the recipient spot 612 may be provided to an enterprise computing system 300, store computing system 400, and/or any other computing system.

Turning now to FIG. 6D, shelves 116 containing the subject parcel 602 and the other parcels 608 are schematically depicted. In this embodiment, the display units 118 may stop providing display unit output 610, based on the subject parcel 602 having been placed on the recipient spot 612. In some embodiments, the display units 118 may stop providing display unit output 610 based upon data received from an enterprise computing system 300, store computing system 400, and/or any other computing system, in response to placement of the subject parcel 602 upon the recipient spot 612. In some embodiments, the one or more display units 118 may provide display unit output 610 based upon other criteria, such as a time interval, an amount of time a parcel has been sitting on the shelf, or if the recipient has indicated that they are en route to pick up the parcel.

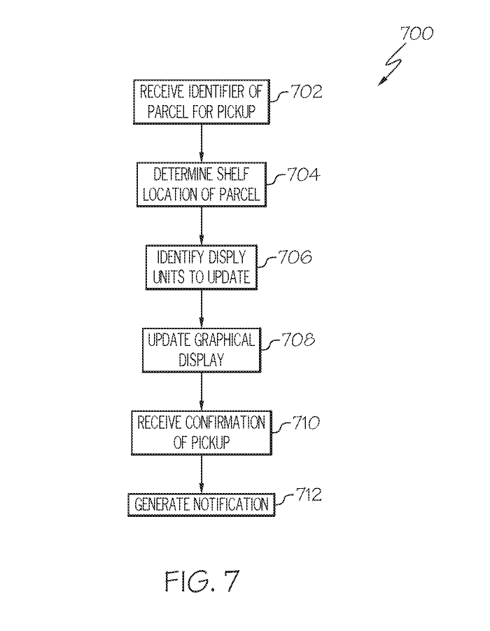

Referring now to FIG. 7 (and FIGS. 1 and 2), a flowchart that graphically illustrates a method 700 for parcel pickup facilitation is provided. As will be apparent from the description below, the method 700 may facilitate the pickup of a parcel previously stored on the plurality of shelves 116 for pickup by a customer.

Still referring to FIG. 7 (and FIGS. 1 and 2), at block 702, an identifier of a parcel to be picked up is received. The identifier may be received in a number of ways, including in response to input provided to the input/output hardware 422 of the store computing system 400, via direct entry into a computing device, lookup of the identifier of the parcel to be picked up based on a customer associated with the parcel, or the like.

Still referring to FIG. 7 (and FIGS. 1 and 2), at block 704, in response to receiving the identifier of the parcel to be picked up, a shelf location on the plurality of shelves 116 on which the parcel to be picked up is stored may be determined. The shelf location may be determined by accessing a database of planogram data or parcel storage location information.

Still referring to FIG. 7 (and FIGS. 1 and 2), at block 706, in response to determining the shelf location on the plurality of shelves 116 of the parcel to be picked up, at least one of the plurality of display units 118 to update may be identified. In some embodiments, the display units to be updated may be identified by the store computing system 400 based on planogram data or parcel storage configuration data stored in the store data repository 436a or planogram data or parcel storage configuration data stored in the enterprise data repository 336a that maps the location of the plurality of shelves 116 of the parcel to be picked up to one or more of the plurality of display units 118.

Still referring to FIG. 7 (and FIGS. 1 and 2), at block 708, in response to identifying the one or more display units to update, a graphical output of the one or more display units identified to be updated in block 706 may be updated to present a parcel location indication. In some embodiments, the parcel location indication may be indicative of a location on a shelf above or below the one or more display units on which the parcel is located. In some embodiments, the graphical output of one or more of the identified display units may be updated to include an arrow pointing to the location of the parcel on the plurality of shelves 116. In some embodiments, the graphical output of one or more of the identified display units may be updated to include an animation indicative of the location of the parcel on the plurality of shelves 116. In some embodiments, a color of the background of one or more of the identified display units may be changed relative to the background of the display units that are not associated with the location of the parcel on the plurality of shelves 116. In other embodiments, a graphical output of the identified display units may be updated in a different manner to graphically distinguish the display units associated with the location of the parcel from the other display units. By presenting the parcel location indication on the appropriate display unit or display units, quick and efficient picking up of the parcel may be facilitated by providing a visual cue that allows quick and accurate identification of the appropriate location of the parcel. In some embodiments, the graphical output of the one or more display units identified to be updated may be updated to present the parcel location indication in response to a message and/or content transmitted from the store computing system 400 to the one or more display units 118 via the store computing network 225. In some embodiments, the resource server logic 443 of the store computing system 400 may render the image or video data to be displayed on the plurality of display units 118 as the updated graphical output. In some embodiments, the shelf integration logic 444 of the store computing system 400 sends the message or content to the plurality of display units 118 that cause the graphical output to be updated. In some embodiments, an audible parcel storage indication may be provided by a speaker positioned near the parcel location.

Still referring to FIG. 7 (and FIGS. 1 and 2), at block 710, confirmation of pickup may be received. The pickup confirmation may be generated in a number of ways, including in response to scanning an identifier of the parcel with a computing device (e.g., with the retail associate device 230, the personal assistant and liaison device 240, the mobile computing device 250), in response to input provided to the input/output hardware 422 of the store computing system 400, via direct entry into a computing device, or the like. In some embodiments, the point of sale system of the store may be used to collect payment prior to authorizing the parcel to be picked up (e.g., if the parcel is a collect on delivery parcel).

Still referring to FIG. 7 (and FIGS. 1 and 2), at block 712, a notification is generated. A notification may be sent to the parcel delivery company computing system 280 to indicate that the parcel has been picked up. A notification may be sent to the customer (e.g., from the enterprise computing system 300 to the customer computing device 290) indicating that a parcel has been picked up at the store. The notification may include many types of data, such as an identifier of the parcel, a location of the store, a time that the parcel of pickup, and the like. Such notifications may facilitate the tracking the parcel by the store, the parcel delivery company and/or the customer.

Although blocks 702-712 have been described as being separate tasks, in other embodiments, the blocks may be combined or omitted. Further, while the tasks of blocks 702-712 have been described as being performed in a particular order, in other embodiments, the tasks may be performed in a different order.

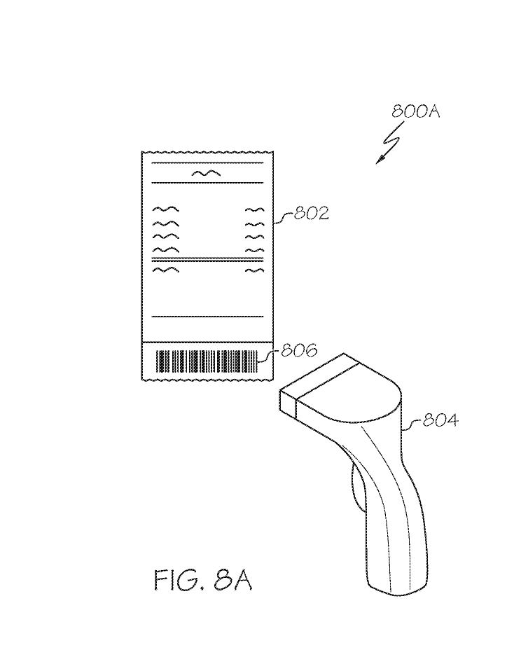

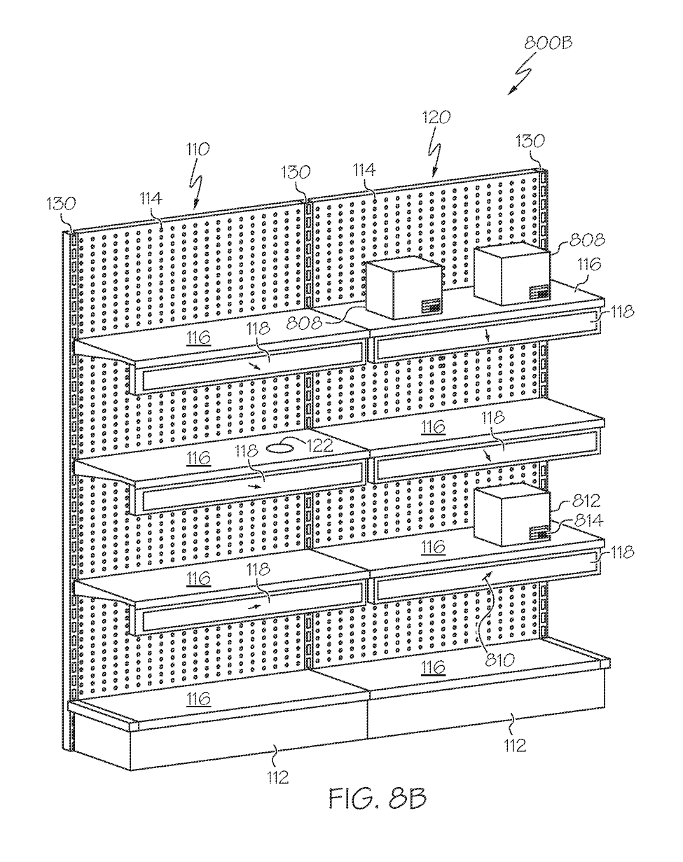

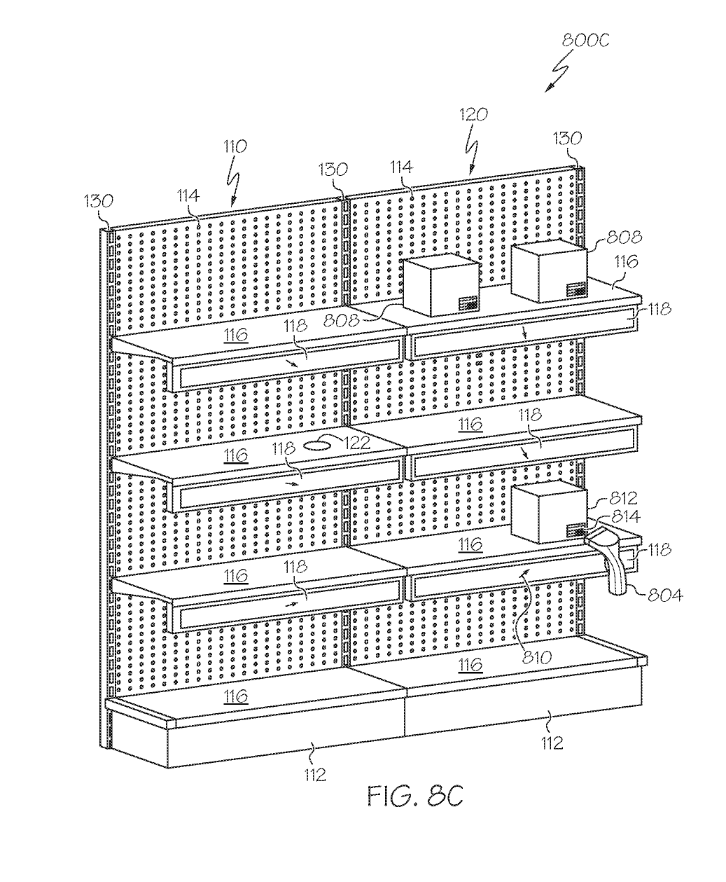

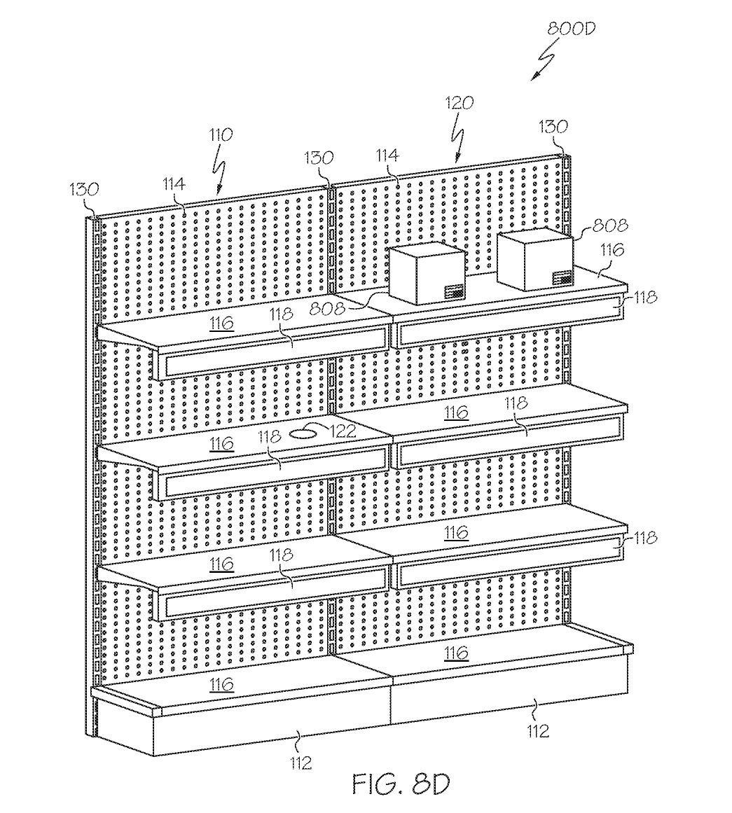

FIG. 8A schematically depicts the scanning of a remote identifier 806 by an input device 804. In this embodiment, an input device 804 is depicted as a hand-held laser scanner, and a remote identifier 806 is depicted as a receipt barcode. In other embodiments, any suitable type of input device 804 (RFID reader, camera, etc.) and remote identifier 806 (QR code, RFID, electronic data, etc.) may be utilized. The remote identifier 806 may be provided by or to an enterprise computing system 300, store computing system 400, or any other computing system. In some embodiments, customer identification, validation, and/or authentication may be further provided. For example, biometrics (facial recognition technology, finger print scanning, eye scanning, etc.) may be utilized to authenticate the customer. Any suitable type biometrics may be utilized, although other mechanisms may be utilized. Biometrics may be implemented via any suitable hardware, such as cameras, microphones, and/or touch-screens, which are discussed above with respect to 432 FIG. 4. For example, the customer may be able to swipe or scan their ID (driver's license, passport, etc.) via a camera or touch-screen, or have it verified by an employee that can enter the ID information or enter general approval information. For example, rather than scanning a remote identifier 806, biometric authentication or ID authentication may utilized to identify the location of a subject parcel 812.

Turning now to FIG. 8B, shelves 116 containing various parcels are schematically depicted. In this embodiment, a subject parcel 812 and other parcels 808 are located on shelves 116. One or more display units 118 may provide display unit output 810 (such as an arrow) indicating where the subject parcel 812 is located on the shelves 116. This may be in response to the remote identifier 806 being scanned. For example, the display unit 118 immediately below the subject parcel 812 may display an arrow as display unit output 810 pointing upward towards the subject parcel 812. In other embodiments, only display units 118 without other parcels 808 may display an arrow pointing towards a subject parcel 812. In some embodiments, any type of visual or audio indicator may be provided as display unit output 610, in order to indicate the location of the subject parcel 812. A display unit 118 may be configured to display an arrow whose direction corresponds to the location of a subject parcel 812. In some embodiments, there may be multiple subject parcels 812 or none at all.

FIG. 8C schematically depicts the subject parcel 812 having its on-parcel identifier 814 scanned by the input device 804. In this embodiment, the on-parcel identifier 814 (QR code, RFID, electronic data, etc.) is compared to the previously-scanned remote identifier 806 discussed above with respect to FIG. 8C. If the on-parcel identifier 814 matches the remote identifier 806, then data indicating a match may be provided to an enterprise computing system 300, store computing system 400, and/or any other computing system. Otherwise, if the on-parcel identifier 814 does not match the remote identifier 806, then a notification may be generated stating that this parcel does not match the previously-scanned remote identifier 806.

Turning now to FIG. 8D, shelves 116 containing the other parcels 808 are schematically depicted. As discussed above, one or more sensors 122 (such as a weight sensor, a motion sensor, or a light sensor) may be utilized to detect that the subject parcel 812 has been removed from a shelf 116. In some embodiments, once the on-parcel identifier 814 has been matched to the remote identifier 806, the status may be updated regarding the space on the shelf 116 upon which the subject parcel 812 was previously located. For example, status may be updated from being occupied to being available for storing future parcels or other parcels 808 already located elsewhere on the shelves 116. Shelf availability data may be provided to an enterprise computing system 300, store computing system 400, and/or any other computing system. The display units 118 may also stop providing display unit output 610, based on the on-parcel identifier 814 being matched to the remote identifier 806. In some embodiments, the display units 118 may stop providing display unit output 810 based upon data provided by an enterprise computing system 300, store computing system 400, and/or any other computing system, in response to the on-parcel identifier 814 having been matched to the remote identifier 806 data.

In some embodiments a checkout process may be utilized for security or audit purposes. For example, a customer or employee retrieving a parcel 602 may be required to, upon retrieving a parcel 602, utilize an automated or employee-operated checkout station or a control gate. In this way, the checkout station may verify that a given parcel 602 has been retrieved by the proper recipient, and that the recipient has likewise retrieved the proper parcel 602. A checkout station may be any suitable type of station (register, automated/self-checkout station, etc.) and may be located in any suitable location with respect to a store in which the parcel 602 resides, such as near entrances, in the store interior, outside the store, etc. A control gate may be any suitable type of gate (automatic, manual) located in any suitable location with respect to a store in which the parcel 602 resides, such as near entrances, in the store interior, outside the store, etc. In some embodiments, an improperly retrieved parcel 602 may be detected at the time of retrieval or at a subsequent time, such as through an audit. If a parcel 602 has been improperly retrieved an alert may be output to employees or other systems for further investigation, such as at store entrances and/or checkout stations. For example, in response to the parcel being removed from the shelf location, an identifier of a person that removed the parcel may be compared to an identifier of an intended recipient of the parcel, and in response to a mismatch between the identifier of the person that removed the parcel and the identifier of the intended recipient, a notification may be output to a control gate or checkout station located at an entrance of a store in which the parcel is located. For example, authentication of the recipient may be performed by an employee and/or a biometric system (e.g., a camera, a microphone, and/or a touchscreen, which are discussed above with respect to 432 FIG. 4). Continuing with this example, the status of the parcel 602 may then be updated from improperly retrieved to properly retrieved.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system comprising:
a plurality of shelves;
a plurality of display units coupled to the shelves;
memory; and
a processor physically coupled to the memory and communicatively coupled to the display units, wherein the processor is configured to:
receive an identifier of a parcel;
in response to receiving the identifier of the parcel, determine a recipient spot among the shelves for storing the parcel;
in response to determining the recipient spot, identify one or more of the display units to update; and
in response to identifying one or more of the display units to update, update graphical output of the identified one or more display units to each present a parcel storage location indication.

2. The system of claim 1, wherein the processor is further configured to generate a notification of a drop-off of the parcel.

3. The system of claim 1, further comprising one or more sensors within or on top of the shelves and communicatively coupled to the processor, wherein the one or more sensors each comprise a motion sensor, a weight sensor, or a light sensor.

4. The system of claim 3, wherein the sensor is a weight sensor and the processor is further configured to compare weight data obtained from a weight sensor to an expected weight value associated with the identifier of the parcel.

5. The system of claim 1, wherein the processor is further configured to update graphical output of one or more of the identified display units to each display an arrow pointing to the recipient spot.

6. The system of claim 1, wherein the processor is further configured to update graphical output to graphically distinguish the identified one or more of the display units to be updated from other display units within the plurality of display units.

7. A system comprising:
a plurality of shelves;
a plurality of display units coupled to the shelves;
memory; and
a processor physically coupled to the memory and communicatively coupled to the display units, wherein the processor is configured to:
receive an identifier of a parcel;
in response to receiving the identifier of the parcel, determine a shelf location among the shelves on which the parcel is stored;
in response to determining the shelf location on which the parcel is stored, identify one or more of the display units to update; and
in response to identifying the one or more display units to update, update a graphical output of the one or more display units identified to be updated to present a parcel storage location indication.

8. The system of claim 7, wherein the processor is further configured to receive confirmation of a pickup of the parcel.

9. The system of claim 7, wherein the processor is further configured to generate a notification of a pickup of the parcel.

10. The system of claim 7 further comprising a speaker configured to provide an audible indication based upon the speaker being located at a shelf location corresponding to where the parcel is stored among the shelves.

11. The system of claim 7, wherein the processor is further configured to update graphical output of the identified display units to graphically distinguish the display units associated with the location on which the parcel is to be placed for later pickup from other display units within the plurality of display units.

12. The system of claim 7 further comprising one or more sensors within or on top of the shelves are communicatively coupled to the processor, wherein the one or more sensors each comprise a motion sensor, a weight sensor, or a light sensor.

13. The system of claim 12, wherein the processor is further configured to generate a notification, based upon motion sensor data, of a pickup of the parcel from the shelf location on which the parcel is stored.

14. The system of claim 12, wherein the processor is further configured to:
generate a notification, based upon motion sensor data, of a pickup of the parcel from the shelf location on which the parcel is stored; and
generate a subsequent notification of pickup of the parcel.

15. The system of claim 7, wherein the processor is further configured to update the one or more display units to provide display unit output based upon an amount of time a parcel has been at the shelf location on which the parcel is stored.

16. The system of claim 7, wherein the processor is further configured to update the one or more display units to provide display unit output based upon a recipient indicating that they are en route to pick up the parcel.

17. The system of claim 7, wherein the processor is further configured to update the one or more display units to each display an arrow pointing to the shelf location on which the parcel is stored.

18. The system of claim 7, wherein the processor is further configured to:
authenticate a recipient based upon facial recognition or login credentials; and
in response to receiving the identifier of the parcel and either the upon facial recognition or login credentials, determine a shelf location among the shelves on which the parcel is stored.

19. The system of claim 7, further comprising a cage on one of the plurality of shelves, wherein the cage is configured to provide access to an authenticated recipient or an employee.

20. A computer-implemented method comprising:
receiving, automatically by a processor, an identifier of a parcel;
in response to receiving the identifier of the parcel, determining a shelf location among the shelves for storing the parcel;
in response to determining the shelf location, identifying one or more of the display units to update; and
in response to identifying one or more of the display units to update, updating graphical output of the identified one or more display units to each present a parcel storage location indication.

21. The computer-implemented method of claim 20, further comprising providing an audible indication based upon a speaker being located at a shelf location among the shelves corresponding to the location on which the parcel is to be placed for later pickup.

22. The computer-implemented method of claim 20, further comprising updating graphical output of one or more of the identified display units to each include an arrow pointing to the location on which the parcel is to be placed for later pickup.

23. The computer-implemented method of claim 20, further comprising:
in response to the parcel being removed from the shelf location, comparing an identifier of a person that removed the parcel to an identifier of an intended recipient of the parcel; and
in response to a mismatch between the identifier of the person that removed the parcel and the identifier of the intended recipient, outputting a notification to a control gate or checkout station located at an entrance of a store in which the parcel is located.
